(19) United States
(12) Patent Application Publication
(10) Pub. No.: US 2026/0289282 A1
(43) Pub. Date: Sep. 24, 2026

(54) TRAINING DEEP NEURAL NETWORKS WITH 4-BIT INTEGERS

(71) Applicants: ROBERT BOSCH GMBH, Stuttgart (DE); TSINGHUA UNIVERSITY, Beijing (CN)

(72) Inventors: Changhao Li, Beijing (CN); Haocheng Xi, Beijing (CN); Jianfei Chen, Beijing (CN); Ze Cheng, Shanghai (CN)

(21) Appl. No.: 19/472,856

(22) PCT Filed: Apr. 21, 2023
(86) PCT No.: PCT/CN2023/089753

§ 371 Date: Oct. 6, 2025

(51) Int. Cl. G06N 3/0495; G06F 17/14; G06F 17/16

(52) U.S. Cl. CPC G06N 3/0495; G06F 17/145; G06F 17/16

(57) ABSTRACT

Techniques for training deep neural networks with 4-bit integers are described. A computer-implemented method for accelerating operations of a deep neural network includes: for each of a plurality of matrix multiplications during forward propagation, obtaining a first matrix by multiplying an activation matrix, which an input of the matrix multiplication, with a block-diagonal Hadamard transform matrix; obtaining a second matrix by multiplying a weight matrix, a transpose of which is another input of the matrix multiplication, with the block-diagonal Hadamard transform matrix; quantizing the first matrix and the second matrix into 4-bit integer matrices; obtaining a resultant matrix by multiplying the quantized first matrix and the transpose of the quantized second matrix; and dequantizing the resultant matrix to a matrix of floating-point representation.

### FIELD

Aspects of the present invention relate generally to artificial intelligence (AI), and more particularly, to training deep neural networks with 4-bit integers.

### BACKGROUND

Artificial neural networks (ANNs), usually simply called neural networks (NNs), as computing systems that were inspired by information processing and distributed communication nodes in biological neural network systems, have been studied for several decades. A deep neural network (DNN), which is an artificial neural network with multiple layers between the input and output layers, has been experiencing a tremendous development in recent years with the great advances in both machine learning algorithms and models and computer hardware performance. Current state-of-the-art models of deep neural networks, such as Transformers introduced in 2017 by Ashish Vaswani et al., have been extensively applied to a wide variety of fields including natural language processing, machine translation, speech recognition, computer vision, and etc., where they have produced results demonstrating remarkable performance.

There is always a need for accelerating operations of deep neural networks, especially considering the operating environments of mobile computing, in-vehicle computing, edge computing, and etc., which each have a relatively low computing capacity. The fundamental idea of quantization, as a type of method for accelerating neural networks, is to replace expensive high-precision representation and computation (e.g., 32-bit floating point (FP32), 16-bit floating point (FP16)) with cheaper low-precision (e.g., 8-bit integer (INT8)) for use within the neural works. Quantization can effectively improve computing efficiency, reduce both memory footprint and storage space, and accordingly, lower the power consumption.

Training neural networks are computationally demanding. Quantizing the activations, weights, and gradients to ultra-low precision is promising to accelerate neural network training. Current research in this area aims to reduce the numerical precision, without sacrificing much model accuracy. Although a series of works have been proposed, there still exist significant optimization challenges to train neural networks at an extremely low 4-bit level.

### SUMMARY

This summary is provided to introduce a selection of concepts in a simplified form that are further described below in the detailed description. This summary is not intended to identify any key features or essential features of the present invention, nor is it intended to be used as an aid in determining the scope of the present invention.

According to an example embodiment of the present invention, a computer-implemented method for accelerating operations of a deep neural network is provided. The method comprises: for each of a plurality of matrix multiplications during forward propagation, obtaining a first matrix by multiplying an activation matrix, which an input of the matrix multiplication, with a block-diagonal Hadamard transform matrix; obtaining a second matrix by multiplying a weight matrix, a transpose of which is another input of the matrix multiplication, with the block-diagonal Hadamard transform matrix; quantizing the first matrix and the second matrix into 4-bit integer matrices; obtaining a resultant matrix by multiplying the quantized first matrix and the transpose of the quantized second matrix; and dequantizing the resultant matrix to a matrix of floating-point representation.

According to another example embodiment of the present invention, a computing device is provided. The computing device comprises memory for storing instructions and one or more processing units coupled to the memory, wherein the instructions, when executed on the one or more processing units, cause the one or more processing units to: for each of a plurality of matrix multiplications during forward propagation, obtain a first matrix by multiplying an activation matrix, which an input of the matrix multiplication, with a block-diagonal Hadamard transform matrix; obtain a second matrix by multiplying a weight matrix, a transpose of which is another input of the matrix multiplication, with the block-diagonal Hadamard transform matrix; quantize the first matrix and the second matrix into 4-bit integer matrices; obtain a resultant matrix by multiplying the quantized first matrix and the transpose of the quantized second matrix; and dequantize the resultant matrix to a matrix of floating-point representation.

According to a further example embodiment of the present invention, a non-transitory computer-readable storage medium is provided, which has stored thereon instructions that, when executed by one or more processing units, cause the one or more processing units to: for each of a plurality of matrix multiplications during forward propagation, obtain a first matrix by multiplying an activation matrix, which an input of the matrix multiplication, with a block-diagonal Hadamard transform matrix; obtain a second matrix by multiplying a weight matrix, a transpose of which is another input of the matrix multiplication, with the block-diagonal Hadamard transform matrix; quantize the first matrix and the second matrix into 4-bit integer matrices; obtain a resultant matrix by multiplying the quantized first matrix and the transpose of the quantized second matrix; and dequantize the resultant matrix to a matrix of floating-point representation.

According to a still further example embodiment of the present invention, a computer program product is provided, which comprises instructions that, when executed by one or more processing units, cause the one or more processing units to: for each of a plurality of matrix multiplications during forward propagation, obtain a first matrix by multiplying an activation matrix, which an input of the matrix multiplication, with a block-diagonal Hadamard transform matrix; obtain a second matrix by multiplying a weight matrix, a transpose of which is another input of the matrix multiplication, with the block-diagonal Hadamard transform matrix; quantize the first matrix and the second matrix into 4-bit integer matrices; obtain a resultant matrix by multiplying the quantized first matrix and the transpose of the quantized second matrix; and dequantize the resultant matrix to a matrix of floating-point representation.

### BRIEF DESCRIPTION OF THE DRAWINGS

Embodiments of the present invention are illustrated by way of example, and not by way of limitation, in the figures in which like references numerals refers to identical or similar elements.

FIG. 1 illustrates a typical architecture of an exemplary neural network.

FIG. 2A is a histogram illustrating original activation distribution of an exemplary transformer model.

FIG. 2B is a histogram illustrating activation distribution of an exemplary transformer model, after Hadamard transformation in accordance with some embodiments of the present invention.

FIG. 3 is a chart illustrating performance variations associated with different group sizes, in accordance with some embodiments of the present invention.

FIG. 4 is a flow chart of an exemplary computer-implemented method in accordance with some embodiments of the present invention.

FIG. 5 is a flow chart of an exemplary matrix multiplication procedure in accordance with some embodiments of the present invention.

FIG. 6 is a flow chart of an exemplary matrix multiplication procedure in accordance with some embodiments of the present invention.

FIG. 7 is a block diagram of an exemplary computing device in accordance with some embodiments of the present invention.

### DETAILED DESCRIPTION

In the following description, numerous specific details are set forth for the purposes of explanation. It should be understood that, however, embodiments of the present disclosure may be practiced without these specific details. In other instances, conventional circuits, structures and techniques have not been shown in detail in order not to obscure the understanding of the disclosure.

References to “one embodiment”, “an embodiment”, “exemplary embodiment”, “some embodiments”, “various embodiments” or the like throughout the description indicate that the embodiment(s) of the present invention/disclosure so described may include particular features, structures or characteristics, but it is not necessarily for every embodiment to include the particular features, structures or characteristics. Further, some embodiments may have some, all or none of the features described for other embodiments.

In the following description, the terms “coupled” and “connected”, along with their derivatives, may be used. It should be understood that these terms are not intended as synonyms for each other. Rather, in particular embodiments, “connected” is used to indicate that two or more elements are in direct physical or electrical contact with each other, while “coupled” is used to indicate that two or more elements co-operate or interact with each other, but they may or may not be in direct physical or electrical contact.

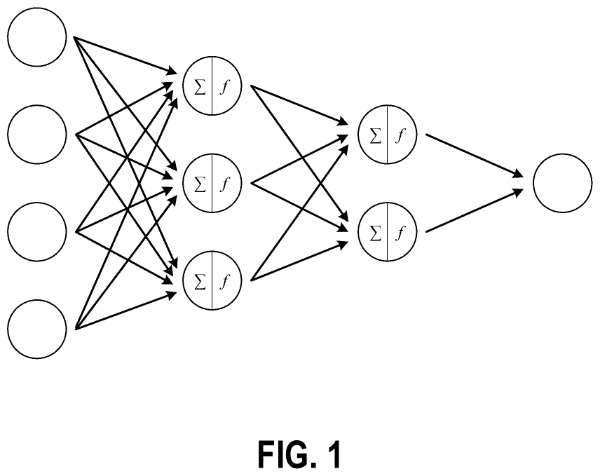

FIG. 1 illustrates a typical architecture of an exemplary neural network, which has an input layer, and output layer, and two hidden layers. In this exemplary neural network, there are four neurons (or “nodes”) in the input layer, three neurons in the first hidden layer, two neuron for in second hidden layer, and one neuron in the output layer. As shown herein, a neuron or node in one of the layers in the exemplary neural network receives, from those neurons in the previous layer, input signals that are passed via connections with different weights. An activation function (denoted as “f”) associated with the neuron is then applied to the weight sum (denoted as “Σ”) of input signals received by the neuron, to generate the output of the neuron, called “activation”, which will act as an input to neuron(s) in the next layer. It can be understood that for the neurons of the input layers, the corresponding activations are equal to the respective input values.

Deep neural network (DNN) is a neural network with multiple layers (that means, very deep) between the input and output layers. Transformer, as a state-of-the art model of deep neural network, is increasingly becoming the model of choice for various tasks such as natural language processing (NLP), and etc. For NLP applications, the deep neural network takes vector representations for words generated based on word-embedding, in some typical scenarios. A typical transformer adopts an encoder-decoder architecture, with the use of an attention mechanism, wherein the encoder consists of encoding layers to generate encoding information about which parts of the inputs are relevant to each other, which is then passed to the next encoding layer as input, and wherein the decoder consists of decoding layers that take all the encoding information and use their incorporated context information to generate an output sequence. Although in the following discussion, transformers are referred to as exemplary models of deep neural networks, it should be noted that the present inventive concept proposed by the present disclosure could also be applied to other types of deep neural networks.

The training process of a deep neural network, a typical example of which is transformer, generally consists of two stages: forward propagation and backpropagation.

### Forward Propagation

The forward propagation of a neural network can be formulated as a composition of linear operations (matrix multiplications) and non-linear operations (GeLU, normalization, softmax, . . . ). According to some embodiments of the present disclosure, all the linear operations, i.e., matrix multiplications, are to be accelerated with 4-bit integer (INT4) arithmetic. For those less-computationally-intensive non-linear operations, they can be left in the original floating-point (FP) format, such as 16-bit floating-point format (FP16). It is to be noted that in the following discussion the FP16 is usually referred to as an example of floating-point representation, and other floating-point formats with higher or lower precision, such as FP32, could also be adopted in implementations of the present disclosure.

All linear operations in a deep neural network, a typical and most-popular instantiation of which is transformer, can be written in the form of matrix multiplication (MM), which is to be accelerated according to some embodiments of the present disclosure. For ease of presentation, the matrix multiplication can be expressed as below:

$$Y = X {W}^{⊤} , \qquad ( 1 )$$

where Y∈ [symbol] ^{N×C}, X∈ [symbol] ^{N×D} and W∈ [symbol] ^{C×D}. The most predominant use case of such matrix multiplication is the fully-connected layer. Consider a transformer with an input shape of (batch size S, sequence length T, dimensionality D). A fully-connected layer can be written as Equation (1), where X is the activation matrix for N=ST tokens, and W is the weight matrix.

Given a FP matrix X, a typical quantization method called learned step size quantization (LSQ) can quantize X to integer with:

$${int}_{{s}_{X}} ( X ) := ⌊ clamp ( X / {s}_{X} , - {Q}_{N} , {Q}_{P} ) ⌉ , \qquad ( 2 )$$

where s_{X} is a learnable floating-point scalar parameter, called step size; the clamp function restricts its input into the range [−Q_{N},Q_{P}]; operator └⋅┐ represents a rounding operation to the nearest integer, and X/s_{X} is to be computed elementwise. The resultant matrix takes values from {−Q_{N}, −Q_{N}+1, . . . , Q_{P}}. According to some embodiments of the present disclosure, since the computation is to be performed with 4-bit integer (INT4), it may be preferable that Q_{N}=Q_{P}=7, especially considering symmetric quantization.

The integer matrix can be dequantized back to floating-point representation:

$$float ( {int}_{{s}_{X}} ( X ) ) = {s}_{X} {int}_{{s}_{X}} ( X ) \approx X , \qquad ( 3 )$$

Similarly, the FP weight matrix W can be quantized as:

$${int}_{{s}_{W}} ( W ) := ⌊ clamp ( W / {s}_{W} , - {Q}_{N} , {Q}_{P} ) ⌉ , \qquad ( 4 )$$

where s_{W} is a learnable floating-point scalar parameter for the weight matrix.

Therefore, the above Equation (1) can be computed approximately as:

$$Y = X {W}^{⊤} \approx {s}_{X} {s}_{W} {int}_{{s}_{X}} ( X ) {int}_{{s}_{W}} {( W )}^{⊤} , \qquad ( 5 )$$

Here, the INT4 matrix multiplication intₛ_{_{X}}(X)intₛ_{_{X}}(W)^{T} can be implemented efficiently on hardware such as tensor-core CPUs.

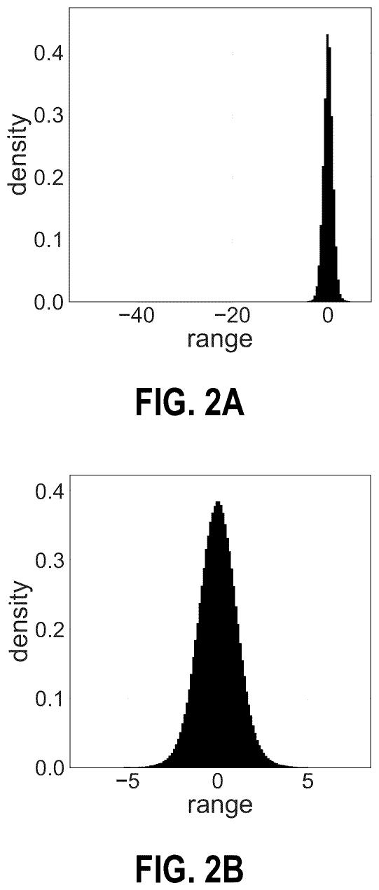

It has been found that, however, directly utilizing the above Equations such as Equation (2) for accelerating training with integer arithmetic may lead to major accuracy degradation. More particularly, the above-mentioned quantization method suffers from the outlier problem. As shown in FIG. 2A which is a histogram illustrating original activation distribution of an exemplary transformer model, activations have some outlier entries, which are much larger in magnitude than other entries. In this case, the step size s_{X} poses a trade-off between quantization granularity and representable numerical range. If s_{X} is large, the outliers can ben represented well at the expense of representing most other entries in a very coarse manner. On the other hand, if Sy is small, the entries outside the range [−Q_{N}s_{X}, Q_{P}s_{X}] have to be truncated.

Transformers tend to store information in these outliers, and such truncation would seriously harm accuracy. The outlier problem is particularly significant when the training task is to fine-tune a pre-trained model on some new downstream tasks.

The outliers in an activation matrix X form a feature-wise structure. They are typically concentrated on a few dimensions, i.e., only a few columns of X are significantly larger than others. According to some embodiments of the present disclosure, Hadamard transform, which is a linear transformation, is introduced herein to solve the outlier problem.

Specifically, the Hadamard transform Hₖ is a 2^{k}×2^{k} matrix, where

$${H}_{0} = 1 , {H}_{k} = \frac{1}{\sqrt{2}} [ \begin{matrix}{H}_{k - 1} & {H}_{k - 1} \\ {H}_{k - 1} & - {H}_{k - 1}\end{matrix} ] , \qquad ( 6 )$$

Hadamard matrices are orthogonal and symmetric:

$${H}_{k} = {H}_{k}^{⊤} = {H}_{k}^{- 1} ,$$

so HₖHₖ=I, ∀k≥0. According to some embodiments of the present disclosure, a block-diagonal matrix H∈ [symbol] D×D is used, where D is a multiple of 2^{k}:

$$H = BlockDiag ( {H}_{k} , … , {H}_{k} ) , \qquad ( 7 )$$

To suppress outliers, a transformed version of the activation matrix X can be quantized as:

$$X = ( X H ) {H}^{⊤} \approx {s}_{X} {int}_{{s}_{X}} ( X H ) {H}^{⊤} , \qquad ( 8 )$$

The practical effect of the Hadamard transformation on suppressing outliers, in a quantization-friendly manner, is demonstrated in FIG. 2B. The Hadamard transformation spreads the information carried in outliers to its nearby entries of the matrix and thus reduce the numerical range of the outliers. The quantization with Hadamard transformation, also called Hadamard quantization (HQ) herein, successfully quantizes the matrix in another linear space which has fewer outliers.

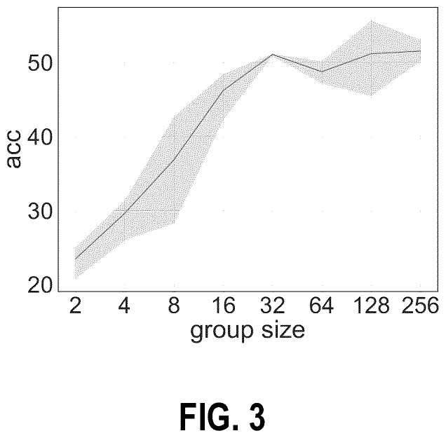

For Hadamard quantization, there is a group size hyperparameter M=2^{k}, as defined in Equation (7). The group size controls a trade-off between accuracy and time complexity. With a larger group size, outlier can be amortized to more entries, at the cost of higher time complexity. FIG. 3 is a chart illustrating performance variations associated with different group sizes, in accordance with some embodiments of the present disclosure. As shown in FIG. 3, a larger group size steadily improves the accuracy, proving the effectiveness of Hadamard quantization, and the improvement begins to saturate at a group size M=2⁵=32. Therefore, according to some embodiments of the present disclosure, the value of k is chosen as k=5.

Similarly, the weight matrix W can be quantized with another block diagonal Hadamard transform matrix H∈ [symbol] ^{D×D}:

$$W = ( W H ) {H}^{⊤} \approx {s}_{W} {int}_{{s}_{W}} ( W H ) {H}^{⊤} , \qquad ( 9 )$$

Combining the quantized matrices, the following can be obtained:

$$Y = X {W}^{⊤} \approx {s}_{X} {s}_{W} {int}_{{s}_{X}} ( X H ) {H}^{⊤} H {int}_{{s}_{W}} {( W H )}^{⊤} = {s}_{X} {s}_{W} {int}_{{s}_{X}} ( X H ) {int}_{{s}_{W}} ( {H}^{⊤} {W}^{⊤} ) , \qquad ( 10 )$$

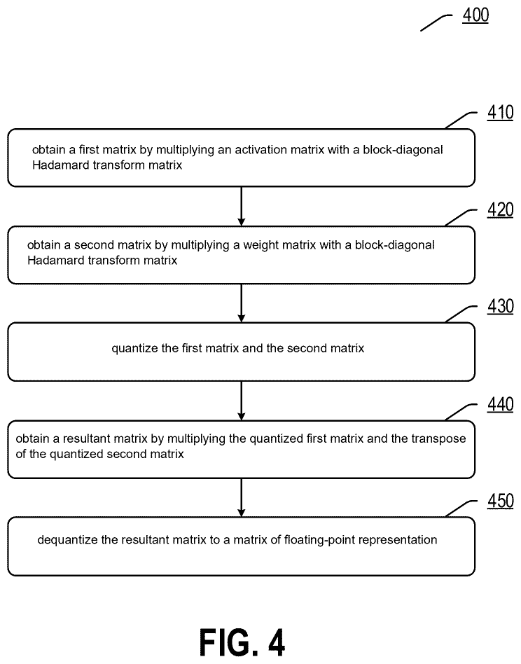

Therefore, according to some embodiments of the present disclosure, a computer-implemented method for accelerating operations of a deep neural network is disclosed, which can be used during a training process of the deep neural network. FIG. 4 is a flow chart of an exemplary method 400 in accordance with some embodiments of the present disclosure.

For each of a plurality of matrix multiplications during forward propagation, the exemplary method 400 begins with Step 410, obtaining a first matrix (XH) by multiplying an activation matrix (X), which an input of the matrix multiplication, with a block-diagonal Hadamard transform matrix (H). It can be understood that the obtained first matrix in this step is still in a floating-point format, such as FP16.

Similarly, the method 400 executes Step 420, obtaining a second matrix (WH) by multiplying a weight matrix (W), a transpose of which is another input of the matrix multiplication, with the block-diagonal Hadamard transform matrix (H). Following the above example, the obtained second matrix is also in FP16.

Then, the method 400 proceeds to Step 430, quantizing the first matrix and the second matrix into 4-bit integer matrices. The quantizing can be implemented using the above-discussed quantization method, learned step size quantization. In some embodiments of the present disclosure, the quantizing may include applying a clamp function to the first matrix and the second matrix, respectively, to restrict each of elements in the first matrix and the second matrix into a range representable by 4-bit integers. Here, a first step size for the activation matrix and a second step size for the weight matrix, each being a parameter of the clamp function, are floating-point scalars learnable during a training process of the deep neural network. In this case, with reference to the above equations, the quantized first matrix may correspond to intₛ_{_{X}}(XH) in Equation (8), while the quantized second matrix may correspond to intₛ_{_{W}}(WH) in Equation (9).

The method 400 continues to execute Step 440, obtaining a resultant matrix by multiplying the quantized first matrix and the transpose of the quantized second matrix. It can bee seen that the matrix multiplication in this step is performed on two 4-bit integer (INT4) matrices, in lieu the original computationally-expensive FP16 matrix multiplication.

Then, in Step 450, dequantizing the resultant matrix to a matrix of floating-point representation. In some embodiments of the present disclosure, with reference to Equation (10), the dequantizing may include multiplying the resultant matrix, which is an integer matrix as described above, with the first step size and the second step size that each are floating-point scalars.

It should be noted that the sequence from Step 410 to step 450 as discussed above does not mean, in any way, that the exemplary method 400 can only be performed in this particular sequential order. Instead, it could be readily appreciated that some of the operations may be performed simultaneously, in parallel, or in a different order. As an example, Steps 410 and 420 may be performed simultaneously. Likewise, other method steps and procedures disclosed in the present disclosure are not necessarily to be performed in the described sequential order.

For time complexity, Step 410 and Step 420 takes O(2^{k}N(D+C)) FP16 multiply-accumulates (MACs); Step 430 and Step 450 takes O(N(D+C))FP 16 MACs in total; and Step 440 takes O(NDC) INT MACs. Comparing with directly using the above-discussed learned step size quantization (LSQ) by referring to Equations (2)-(5), the amount of FP16 MACs increases by 2^{k} times, from O(N(D+C)) to O(2^{k}N(D+C)). However, the Hadamard quantization proposed herein is still much cheaper than an FP16 matrix multiplication given 2^{k}<<D, 2^{k}<<C.

It is to be noted that although the above discussions are made under the context of the training process of the deep neural network, the technique discussed herein could also be applied to accelerate the inference process that uses a trained neural network to make predictions on new data, which is also a type of forward propagation.

### Backpropagation

The backpropagation stage of the training process for the deep neural network refers to a procedure that feeds the loss (or cost), calculated by using a loss function [symbol] (e.g., cross entropy), back through the neural network layers to adjust parameters (e.g., weights) within the neural network, by using some form of gradient descent. Here, the loss function [symbol] is to measure the difference between the predicted output of the deep neural network and the expected output (or the ground truth), and the backpropagation aims to minimize the loss function.

For accelerating the backpropagation of the training process, now consider the linear operation of matrix multiplication defined in Equation (10), which has four inputs: activation X, weight W, and step sizes s_{X}, s_{W}. Given the gradient ∇_{Y} [symbol] (for simplicity, hereinafter denoted as ∇_{Y}) of the loss function [symbol] with regard to the output Y of the matrix multiplication, the gradients for all of the four inputs are to be computed.

First, by the straight-through estimator └x┐′=1 and the chain rule, the weight gradient and the activation gradient can be calculated as below:

$${∇}_{W} = {s}_{X} ( {∇}_{Y}^{⊤} \hat{X} ∘ {𝕀}_{W} ) {H}^{⊤} \qquad ( 11 )$$

$${∇}_{x} = {s}_{W} {𝕀}_{X} ∘ {∇}_{Y} \hat{W} {H}^{⊤} ,$$

where \hat{X}=intₛ_{_{X}}(XH), Ŵ=intₛ_{_{W}}(WH), [symbol] _{X}= [symbol] (−Q_{N}≤X/s_{X}≤Q_{P}), and [symbol] _{W}= [symbol] (−Q_{N}≤W/s_{W}≥Q_{P}), where [symbol] _{X} and [symbol] _{W} are 0/1 matrices, and operator º represents element-size multiplication.

According to some embodiments of the present disclosure, among the others, the matrix multiplication of the FP16 gradient matrix ∇_{Y} with an INT4 matrix \hat{X} or Ŵ, i.e., two matrix multiplications

$${Δ}_{Y}^{⊤} \hat{X} and {∇}_{Y} \hat{W}$$

and ∇_{Y}Ŵ in the above Equation, will be accelerated by quantizing ∇_{Y} to INT4.

It has been found that, the gradient matrix ∇_{Y} tends to be very sparse along the training process, and the sparsity has a structure: few rows (i.e., tokens) of ∇_{Y} have large entries, while most of the other rows are close to an all-zero vector. Such a structural sparsity arises from the heavy overparameterization of modern neural networks, and it is found that for pretraining tasks, such a structural sparsity quickly emerges after only a few training epochs, while for fine-tuning tasks, the gradient is always sparse during the whole training process.

As described above, may rows of the gradient are so small that they have little impact on the parameter gradient, yet they waste abundant computation. On the other hand, the large rows may not be accurately represented with 4-bit integers (INT4).

In view of the above problems, for computations associated with the FP16 gradient matrix ∇_{Y}, this matrix is firstly to be split into higher 4 bits and lower 4 bits:

$${∇}_{Y} \approx {s}_{↑} {∇}_{Y}^{↑} + {s}_{↓} {∇}_{Y}^{↓} , \qquad ( 12 )$$

where s⬆, s⬇ are two floating-point scalars, and

$${∇}_{Y}^{↑} , {∇}_{Y}^{↓}$$

are INT4 matrices representing the higher and lower 4 bits of ∇_{Y}, respectively.

According to some embodiments of the present disclosure, this bit splitting (BS) can be implemented by first quantizing the FP16 gradient matrix ∇_{Y} into the first (higher) INT4 gradient matrix

$${∇}_{Y}^{↑} , as {∇}_{Y} \approx {s}_{↑} {∇}_{Y}^{↑} ;$$

and then, quantizing the residual, i.e., the difference between ∇_{Y} and

$${s}_{↑} {∇}_{Y}^{↑} ,$$

into the second (lower) INT4 gradient matrix

$${∇}_{Y}^{↓} , as {∇}_{Y} - {s}_{↑} {∇}_{Y}^{↑} \approx {s}_{↓} {∇}_{Y}^{↓}$$

The bit splitting can be viewed as an INT8 representation of the original gradient matrix ∇_{Y}, where

$${∇}_{Y}^{↑} and {∇}_{Y}^{↓}$$

are the higher and lower 4 bits of the INT8 representation, respectively.

Next, discussions will be made regarding the computation of with the weight gradient and the activation gradient.

### Weight Gradient

As discussed earlier, weight gradient involves the matrix multiplication

$${∇}_{Y}^{T} \hat{X} ,$$

where ∇_{Y} ∈ [symbol] ^{N×C}, and \hat{X} is an N×D INT4 matrix. This matrix multiplication can be approximated as:

$${∇}_{Y}^{T} \hat{X} \approx ( {s}_{↑} {∇}_{Y}^{{↑}^{⊤}} + {s}_{↓} {∇}_{Y}^{{↓}^{⊤}} ) \hat{X} = {∇}_{Y}^{{↕}^{⊤}} {X}^{↕} , \qquad ( 13 )$$

where

$${∇}_{Y}^{↕} = [ {s}_{↑} {∇}_{Y}^{↑} ; {s}_{↓} {∇}_{Y}^{↓} ] ∈ {ℝ}^{2 N \times C} ,$$

which is to be an 2N×D INT4 matrix.

Equation (13) represents that the matrix multiplication of an FP16 matrix, the transpose of the gradient matrix ∇_{Y}, and the INT4 matrix \hat{X} can be approximated by two INT4 matrix multiplications

$${∇}_{Y}^{{↑}^{⊤}} \hat{X} and {∇}_{Y}^{{↓}^{⊤}} \hat{X} .$$

More specifically, according to some embodiments of the present disclosure, the matrix multiplication

$${∇}_{Y}^{⊤} \hat{X}$$

discussed herein can be implemented by the following steps: obtaining a matrix

$${∇}_{Y}^{{↑}^{⊤}} \hat{X}$$

by multiplying the following steps: obtaining a matrix transpose of the first (higher) INT4 gradient matrix

$${∇}_{Y}^{↑}$$

ana the INT4 matrix X; obtaining a matrix

$${∇}_{Y}^{{↓}^{⊤}} \hat{X}$$

by multiplying the transpose of the second (lower) INT4 gradient matrix

$${∇}_{Y}^{↓}$$

and the INT4 matrix \hat{X}; dequantizing the obtained two matrices into matrices of floating-point representation (e.g., FP16); and then, obtaining a resultant matrix by summing up the dequantized two matrices.

Such matrix multiplication in Equation (13) is accurate since the gradient matrix ∇_{Y} is represented with 8 bits, effectively avoiding the situations where, if an element in the gradient matrix is quantized into one 4-bit integer only, the imprecise gradients may adversely slow down the training process and even cause the training to be unstable or diverge.

Further, comparing to a naïve quantization of ∇_{Y} to INT4, the bit splitting described above may double the amount of INT4 operations for matrix multiplication. According to some embodiments of the present disclosure, leverage score sampling (LSS) is proposed herein to cut the operations of Equation (13) by half, to the same amount as the naïve matrix multiplication

$${S}_{↑} {∇}_{Y}^{{↑}^{⊤}} \hat{X} .$$

That means, by leveraging structural sparsity, some small rows of the gradient matrix may be dropped and the saved computation could therefore be used to represent large rows more accurately.

The matrix multiplication of Equation (13) can be written as the sum of 2N matrix matrices:

$${∇}_{Y}^{{↕}^{⊤}} {X}^{↕} = {\sum }_{i = 1}^{2 N} {∇}_{{Y}_{: , i}}^{↕} {X}_{i}^{↕} = {\sum }_{i}^{2 N} {∇}_{{W}_{i}} , \qquad ( 14 )$$

where

$${∇}_{{W}_{i}} = {∇}_{{Y}_{: , i}}^{{↕}^{⊤}} {X}_{i}^{↕} .$$

Due to the sparsity of ∇_{Y}, the matrices ∇_{W}_{ᵢ} differ in magnitude and small matrices can be discarded without having a big influence on the result.

According to some embodiments of the present disclosure, in obtaining the matrix

$${∇}_{Y}^{{↑}^{⊤}} \hat{X}$$

and the matrix

$${∇}_{Y}^{{↓}^{⊤}} \hat{X}$$

as discussed above, rows in the first (higher) INT4 gradient matrix and the second (lower) INT4 gradient matrix may be sampled, with per-row random masks (mᵢ) that follow Bernoulli distribution with corresponding per-row probabilities (pᵢ). More specifically, each ∇_{W}_{ᵢ} is assigned a probability pᵢ ∈[0, 1], i=1, . . . , 2N, that satisfies

$${\sum }_{i = 1}^{2 N} {p}_{i} = N .$$

Random masks mᵢ are defined to follow the Bernoulli distribution with the parameter pᵢ, denoted as mᵢ~Bern(pᵢ), and a diagonal matrix \tilde{M} is defined as

$$\tilde{M} = diag ( \frac{{m}_{1}}{{p}_{1}} , … , \frac{{m}_{2 N}}{{p}_{2 N}} ) .$$

### So,

$${∇}_{Y}^{{↕}^{⊤}} {X}^{↕}$$

can be unbiasedly approximated as below:

$${∇}_{Y}^{{↕}^{⊤}} {X}^{↕} \approx {∇}_{Y}^{{↕}^{⊤}} \tilde{M} {X}^{↕} = {\sum }_{i = 1}^{2 N} \frac{{m}_{i}}{{p}_{i}} {∇}_{{Y}_{: , i}}^{{↕}^{⊤}} {X}_{i}^{↕} , \qquad ( 15 )$$

In expectation, there are only N nonzero mᵢs. Therefore, with the leverage score sampling, the cost of matrix multiplication is reduced by half. A per-row coefficient, called herein the leverage score for weight gradient, is

$${c}_{i} := ‖ {∇}_{{Y}_{i , :}}^{↕} ‖ ‖ {X}_{i , :}^{↕} ‖ ,$$

which can be easily computed in low time complexity. When pᵢ ∝cᵢ, the variance for

$${\sum }_{i = 1}^{2 N} \frac{{m}_{i}}{{p}_{i}} {∇}_{{Y}_{: , i}}^{{↕}^{⊤}} {X}_{i}^{↕}$$

achieves its minimum.

Here, M^{⬆} is defined to be the top-left N×N submatrix of M and M^{⬇} is defined to be the bottom-right N×N submatrix of M. Therefore,

$${∇}_{Y}^{{↕}^{⊤}} \tilde{M} {X}^{↕} = {s}_{↑} {∇}_{Y}^{{↑}^{⊤}} {\tilde{M}}^{↑} \hat{X} + {s}_{↓} {∇}_{Y}^{{↓}^{⊤}} {\tilde{M}}^{↓} \hat{X} , \qquad ( 16 )$$

which can be implemented by two INT4 matrix multiplications with sampled rows/columns.

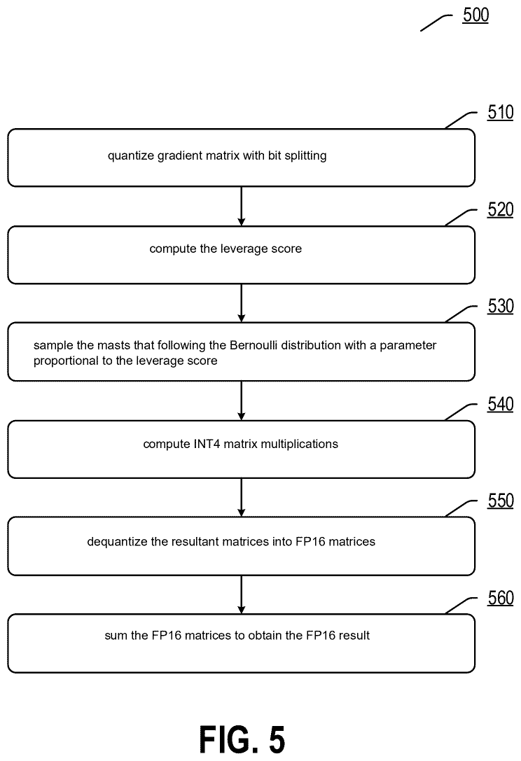

Therefore, with the above equations, a matrix multiplication procedure 500 for computing the weight gradient may be as follows, as shown in FIG. 5:

Step 510: Quantizing ∇_{Y} with bit splitting to obtain in INT4;

$${∇}_{Y}^{↑} and {∇}_{Y}^{↓}$$

Step 520: Computing the leverage score

$${c}_{i} := ‖ {∇}_{{Y}_{i , :}}^{↕} ‖ ‖ {X}_{i , :}^{↕} ‖$$

### in FP16;

Step 530: Sampling the masks mᵢ that follow the Bernoulli distribution with the parameter pᵢ, where pᵢ ∝cᵢ;

Step 540: Computing INT4 matrix multiplications

$${∇}_{Y}^{↑ T} {\tilde{M}}^{↑} \hat{X} and {∇}_{Y}^{↓ T} {\tilde{M}}^{↓} \hat{X} ;$$

Step 550: Dequantizing the resultant matrices into FP16 matrices; and

Step 560: Summing up the FP16 matrices to obtain the FP16 result

$${∇}_{Y}^{↕ T} \tilde{M} {X}^{↕} .$$

The two INT4 matrix multiplications in Step 540 take about 2NCD INT4 MACs in expectation. The overhead of all the other steps is O(NC+ND) in total.

### Activation Gradient

Similar to the discussion of the weight gradient, the matrix multiplication ∇_{Y}Ŵ in the calculation of the activation gradient can be written as:

$${∇}_{Y} \hat{W} \approx ( {s}_{↑} {∇}_{Y}^{↑} + {s}_{↓} {∇}_{Y}^{↓} ) \hat{W} = {s}_{↑} {∇}_{Y}^{↑} \hat{W} + {s}_{↓} {∇}_{Y}^{↓} \hat{W} = ( {\hat{I}}^{↕} {∇}_{Y}^{↕} ) \hat{W} , \qquad ( 17 )$$

wherein

$${∇}_{Y}^{↕} = [ {s}_{↑} {∇}_{Y}^{↑} ; {s}_{↓} {∇}_{Y}^{↓} ] ∈ {ℝ}^{2 N \times C} ,$$

as described above, and

$${\hat{I}}^{↕} = [ I I ]$$

which is to be an N×2N INT4 matrix, I being a N×N identity matrix.

Equation (17) represent that the matrix multiplication of the FP16 gradient matrix ∇_{Y} and the INT4 matrix Ŵ can also be approximated by two INT4 matrix multiplications

$${∇}_{Y}^{↑} \hat{W} and {∇}_{Y}^{↓} \hat{W} .$$

More specifically, according to some embodiments of the present disclosure, the matrix multiplication ∇_{Y}Ŵ discussed herein can be implemented by the following steps: obtaining a matrix

$${∇}_{Y}^{↑} \hat{W}$$

by multiplying the first (higher) INT4 integer gradient matrix

$${∇}_{Y}^{↑}$$

and the INT4 matrix Ŵ; obtaining a matrix

$${∇}_{Y}^{↓} \hat{W}$$

by multiplying the second (lower) INT4 gradient matrix

$${∇}_{Y}^{↓}$$

and the INT4 matrix Ŵ; dequantizing the obtained two matrices into matrices of floating-point representation (e.g., FP16); and then, obtaining a resultant matrix by summing up the dequantized two matrices.

But different from the weight gradient, now the focus is on

$${\hat{I}}^{↕} {∇}_{Y}^{↕}$$

in Eq. (17) and leverage score sampling is done on this matrix multiplication. This matrix multiplication can similarly be written as the sum of 2N smaller multiplications:

$${\hat{I}}^{↕} {∇}_{Y}^{↓} = {\sum }_{i = 1}^{2 N} {\hat{I}}_{: , i}^{↕} {∇}_{{Y}_{i}}^{↕} = {\sum }_{i = 1}^{2 N} {∇}_{{Y}_{i}} , \qquad ( 18 )$$

where

$${∇}_{{Y}_{i}} = {\hat{I}}_{: , i}^{↕} {∇}_{{Y}_{i}}^{↕} .$$

According to some embodiments of the present disclosure, in obtaining the matrix

$${∇}_{Y}^{↑} \hat{W}$$

and the matrix

$${∇}_{Y}^{↓} \hat{W}$$

as discussed above, rows in the first (higher) INT4 gradient matrix and the second (lower) INT4 gradient matrix may be sampled, with per-row random masks mᵢ that follow Bernoulli distribution with corresponding per-row probabilities pᵢ. More specifically, each ∇_{Y}_{ᵢ} is assigned a probability pᵢ ∈[0, 1], i=1, . . . , 2N, that satisfies

$${\sum }_{i = 1}^{2 N} {p}_{i} = N .$$

distribution with the parameter pᵢ, denoted as mᵢ~Bern(pᵢ), and a diagonal matrix \tilde{M} is defined as

$$\tilde{M} = diag ( \frac{{m}_{1}}{{p}_{1}} , … , \frac{{m}_{2 N}}{{p}_{2 N}} ) .$$

### So,

$${\hat{I}}^{↕} {∇}_{Y}^{↕}$$

can be unbiasedly approximated as below:

$${\hat{I}}^{↕} {∇}_{Y}^{↕} \approx {\hat{I}}^{↕} \tilde{M} {∇}_{Y}^{↕} = {\sum }_{i = 1}^{2 N} \frac{{m}_{i}}{{p}_{i}} {\hat{I}}_{: , i}^{↕} {∇}_{{Y}_{i}}^{↕} , \qquad ( 19 )$$

Here, the leverage score for activation gradient would be

$${c}_{i} := ‖ {∇}_{{Y}_{i}}^{↕} ‖ ,$$

and the variance for

$${\sum }_{i = 1}^{2 N} \frac{{m}_{i}}{{p}_{i}} {\hat{I}}_{: , i}^{↕} {∇}_{{Y}_{i}}^{↕}$$

achieves its minimum when pᵢ ∝cᵢ.

Again, M^{⬆} is defined to be the top-left N×N submatrix of M and M^{⬇} is defined to be the bottom-right N×N submatrix of M, and the matrix multiplication Equation (17) can be decomposed as two INT4 matrix multiplications:

$$( {\hat{I}}^{↕} \tilde{M} {∇}_{Y}^{↕} ) \hat{W} = {s}_{↑} I {\tilde{M}}^{↑} {∇}_{Y}^{↑} \hat{W} + {s}_{↓} I {\tilde{M}}^{↓} {∇}_{Y}^{↓} \hat{W} , \qquad ( 20 )$$

In this case,

$$I {\hat{M}}^{↑} {∇}_{Y}^{↑} and I {\tilde{M}}^{↓} {∇}_{Y}^{↓}$$

both only have parts of its rows being non-zero, and the rest rows are zeros since they are discarded. Then, when multiplying it by Ŵ, there are half of rows being zeros in

$$I {\tilde{M}}^{↑} {∇}_{Y}^{↑} \hat{W} and I {\tilde{M}}^{↓} {∇}_{Y}^{↓} \hat{W} ,$$

so there is no need to calculate them, and half of the computation is cut off in this case.

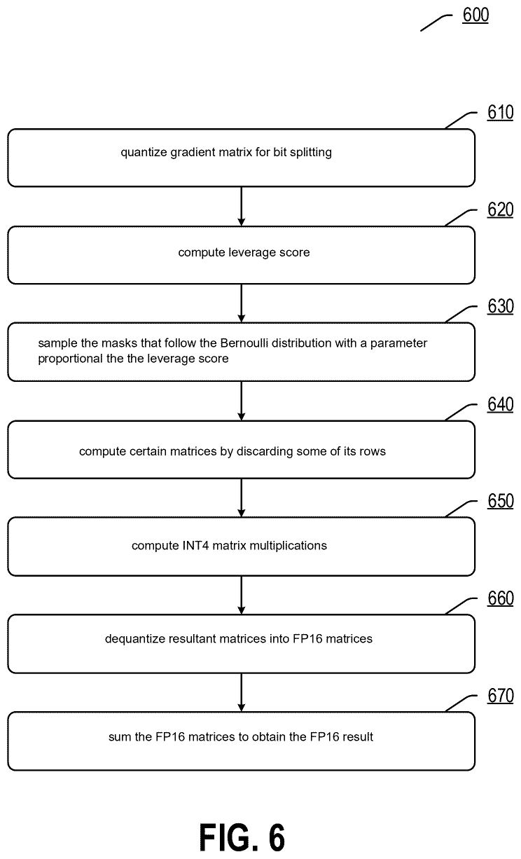

Therefore, with the above equations, a matrix multiplication procedure 600 for computing the activation gradient may be as follows, as shown in FIG. 6:

Step 610: Quantizing ∇_{Y} with bit splitting to obtain

$${∇}_{Y}^{↑} and {∇}_{Y}^{↓}$$

### in INT4;

Step 620: Computing the leverage score

$${c}_{i} := ‖ {∇}_{{Y}_{i}}^{↕} ‖$$

### in FP16;

Step 630: Sampling the masks mᵢ that follow the Bernoulli distribution with the parameter pᵢ, where pᵢ ∝cᵢ;

Step 640: Computing by discarding some of its

$$I {\tilde{M}}^{↑} {∇}_{Y}^{↑} and I {\tilde{M}}^{↓} {∇}_{Y}^{↓}$$

by discarding some of its rows;

Step 650: Computing INT4 matrix multiplications

$$I {\tilde{M}}^{↑} {∇}_{Y}^{↑} \hat{W} and I {\tilde{M}}^{↓} {∇}_{Y}^{↓} \hat{W} ;$$

Step 660: Dequantizing the resultant matrices into FP16 matrices; and Step 670: Summing up the FP16 matrices to obtain the FP16 result

$$( {\hat{I}}^{↕} {∇}_{Y}^{↕} ) \hat{W} .$$

The two matrix multiplications in Step 640 take about 2NCD INT4 MACs in expectation.

### Learning Quantizer Parameters

The following is to discuss how to learn or optimize the quantization step sizes s_{X}, s_{W}. Following the chain rule, the gradients for the step sizes s_{X}, s_{W} can be written as:

$${∇}_{{s}_{w}} = g ( {s}_{w} ) {∇}_{Y}^{T} \hat{X} ∘ {δ}_{w} ( {s}_{w} ) \\ {∇}_{{s}_{x}} = g ( {s}_{x} ) {∇}_{Y} \hat{W} ∘ {δ}_{x} ( {s}_{x} ) , \qquad ( 21 )$$

where g(s_{W})=1/\sqrt{QₚN_{W}}, g(s_{X})=1/\sqrt{QₚN_{X}}, N_{W} and N_{X} the number of elements of weight and activation, δ_{W}(s_{W})=intₛ_{_{W}}(W)− [symbol] _{W}º(W/s_{W}), and δ_{X}(s_{X})=intₛ_{_{X}}(X)− [symbol] _{X}º(X/s_{X}).

For computing ∇ₛ_{_{W}} and ∇ₛ_{_{X}}, the most expensive matrix multiplications are

$${∇}_{Y}^{T} \hat{X} and {∇}_{Y} \hat{W} ,$$

which however have already been calculated during previous calculations, so it does not require extra computation. The elementwise multiplication with δ_{W}(s_{W}) and δ_{X}(s_{X}) require minor computation.

Further, according to some embodiments of the present disclosure, whether or not to start optimizing each of the first step size and the second step size is to be determined, when the rate of change of the corresponding step size over one or more iterations in the training process is less than a pre-determined threshold, or when a pre-determined number of epochs has been trained in the training process. Thereby the cold start problem, which happens when the neural network is trained from scratch, can be effectively avoided.

Combining quantization techniques for forward and backward propagation, the mechanism proposed in the present disclosure uses INT4 matrix multiplications for all linear operations in deep neural networks, such as transformers. The mechanism disclosed herein is evaluated for training transformers on a wide variety of tasks, including natural language understanding, question answering, machine translation, image classification, and etc., achieving competitive or superior accuracy compared with existing works. Training deep neural networks at an extremely low 4-bit level, with the mechanism disclosed herein, can effectively reduce the demand for computer hardware resources including, but not limited to, arithmetic units, registers, memory and storage, compared to those solutions with expensive high-precision representation and computation, and accordingly, it significantly improves computing efficiency and lowers the power consumption. More, the mechanism disclosed herein is compatible with contemporary hardware like GPUs, since it does not require custom numerical formats that are needed by existing works. Still further, a prototypical implementation of the mechanism disclosed herein demonstrates superior speed that is 1.7-2.9 times faster than the FP16 matrix multiplication baseline.

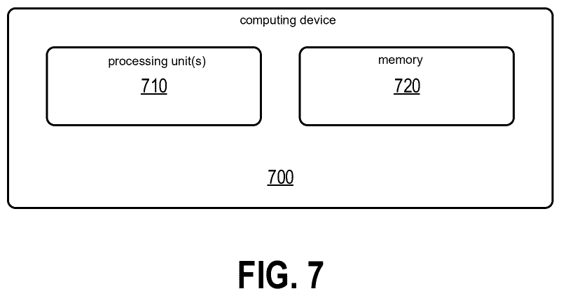

Turning now to FIG. 7, a block diagram of an exemplary computing device 700 in accordance with some embodiments of the present disclosure is illustrated. As illustrated herein, the computing device 700 may comprise one or more processing units 710 and memory 720. The one or more processing units 710 may include any type of general-purpose processing units/cores (for example, but not limited to CPU, GPU), or application-specific processing units, cores, circuits, controllers or the like. The memory 720, coupled to the one or more processing units 710, may include any type of medium that may be used to store data. The memory 720 is configured to store instructions that, when executed, cause the one or more processing units 710 to perform operations of any method described herein, including but not limited to the exemplary method 400, the exemplary procedure 500, the exemplary procedure 600.

Various embodiments described herein may include, or may operate on, a number of components, elements, units, modules, instances, or mechanisms, which may be implemented using hardware, software, firmware, or any combination thereof. Examples of hardware may include, but not be limited to, devices, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor devices, chips, microchips, chip sets, and so forth. Examples of software may include, but not be limited to, software components, programs, applications, computer programs, application programs, system programs, machine programs, operating system software, middleware, software modules, routines, subroutines, functions, methods, procedures, software interfaces, application programming interfaces (API), instruction sets, computer code, computer code segments, words, values, symbols, or any combination thereof.

Determining whether an embodiment is implemented using hardware, software and/or firmware may vary in accordance with any number of factors, such as desired computational rate, power levels, heat tolerances, processing cycle budget, input data rates, output data rates, memory resources, data bus speeds and other design or performance constraints, as desired for a given embodiment.

Some embodiments described herein may comprise an article of manufacture. An article of manufacture may comprise a storage medium. Examples of storage medium may include volatile and nonvolatile, removable and non-removable media implemented in any method or technology for storage of information, such as computer readable instructions, data structures, program modules, or other data. Storage medium may include, but not be limited to, random-access memory (RAM), read-only memory (ROM), programmable read-only memory (PROM), erasable programmable read-only memory (EPROM), electrically erasable programmable read-only memory (EEPROM), flash memory or other memory technology, compact disc (CD), digital versatile disk (DVD) or other optical storage, magnetic cassette, magnetic tape, magnetic disk storage or other magnetic storage devices, or any other medium which can be used to store information. In some embodiments, an article of manufacture may store executable computer program instructions that, when executed by one or more processing units, cause the processing units to perform operations described herein. The executable computer program instructions may include any suitable type of code, such as source code, compiled code, interpreted code, executable code, static code, dynamic code, and the like. The executable computer program instructions may be implemented using any suitable high-level, low-level, object-oriented, visual, compiled and/or interpreted programming language.

Some examples of the present disclosure described herein are given below.

Example 1 may include a computer-implemented method for accelerating operations of a deep neural network, comprising: for each of a plurality of matrix multiplications during forward propagation, obtaining a first matrix by multiplying an activation matrix, which an input of the matrix multiplication, with a block-diagonal Hadamard transform matrix; obtaining a second matrix by multiplying a weight matrix, a transpose of which is another input of the matrix multiplication, with the block-diagonal Hadamard transform matrix; quantizing the first matrix and the second matrix into 4-bit integer matrices; obtaining a resultant matrix by multiplying the quantized first matrix and the transpose of the quantized second matrix; and dequantizing the resultant matrix to a matrix of floating-point representation.

Example 2 may include the subject matter of Example 1, wherein the method is to be performed during a training process of the deep neural network.

Example 3 may include the subject matter of Example 1, wherein the block-diagonal Hadamard transform matrix is a block-diagonal matrix consisting of multiple Hadamard transform matrices Hₖ, wherein k=5.

Example 4 may include the subject matter of Example 1, wherein the quantizing includes: applying a clamp function to the first matrix and the second matrix, respectively, to restrict each of elements in the first matrix and the second matrix into a range representable by 4-bit integers, wherein a first step size for the activation matrix and a second step size for the weight matrix, each being a parameter of the clamp function, are floating-point scalars learnable during a training process of the deep neural network.

Example 5 may include the subject matter of Example 4, wherein the dequantizing includes: multiplying the resultant matrix with the first step size and the second step size.

Example 6 may include the subject matter of Example 4, wherein whether or not to start optimizing each of the first step size and the second step size is to be determined when the rate of change of the corresponding step size over one or more iterations in the training process is less than a pre-determined threshold, or when a pre-determined number of epochs has been trained in the training process.

Example 7 may include the subject matter of Example 1, wherein the method further comprises, during backpropagation in a training process of the deep neural network: for computations associated with a gradient matrix representing gradient of a loss function with regard to the output of the matrix multiplication, splitting the gradient matrix into a first 4-bit integer gradient matrix and a second 4-bit integer gradient matrix, wherein the first 4-bit integer gradient matrix and the second 4-bit integer gradient matrix represent higher 4 bits and lower 4 bits of the gradient matrix, respectively.

Example 8 may include the subject matter of Example 7, wherein the splitting includes: quantizing the gradient matrix into the first 4-bit integer gradient matrix associated with a first floating-point scalar; and quantizing the difference between the gradient matrix and a product of the first 4-bit integer gradient matrix and the first floating-point scalar into the second 4-bit integer gradient matrix associated with a second floating-point scalar.

Example 9 may include the subject matter of Example 8, wherein the method further comprises, for computation of weight gradient that involves a second matrix multiplication of a transpose of the gradient matrix with the quantized first matrix: obtaining a third matrix by multiplying the transpose of the first 4-bit integer gradient matrix and the quantized first matrix; obtaining a fourth matrix by multiplying the transpose of the second 4-bit integer gradient matrix and the quantized first matrix; dequantizing the third matrix and the fourth matrix into matrices of floating-point representation; and obtaining a resultant fifth matrix by summing up the dequantized third matrix and the dequantized fourth matrix.

Example 10 may include the subject matter of Example 9, wherein in obtaining the third matrix and obtaining the fourth matrix, rows in the first 4-bit integer gradient matrix and the second 4-bit integer gradient matrix are sampled, with per-row random masks that follow Bernoulli distribution with corresponding per-row probabilities.

Example 11 may include the subject matter of Example 10, wherein each of the per-row probabilities is proportional to a corresponding per-row coefficient being equal to a product of a first norm associated with the quantized gradient matrix and a second norm associated with the quantized first matrix.

Example 12 may include the subject matter of Example 7, wherein the method further comprises, for computation of activation gradient that involves a third matrix multiplication of the gradient matrix with the quantized second matrix, obtaining a sixth matrix by multiplying the first 4-bit integer gradient matrix and the quantized second matrix; obtaining a seventh matrix by multiplying the second 4-bit integer gradient matrix and the quantized second matrix; dequantizing the sixth matrix and the seventh matrix into matrices of floating-point representation; and obtaining a resultant eighth matrix by summing up the dequantized six matrix and the dequantized seven matrix.

Example 13 may include the subject matter of Example 12, wherein in obtaining the sixth matrix and obtaining the seventh matrix, rows in the first 4-bit integer gradient matrix and the second 4-bit integer gradient matrix are sampled, with per-row random masks that follow Bernoulli distribution with corresponding per-row probabilities.

Example 14 may include the subject matter of Example 13, wherein each of the per-row probabilities is proportional to a corresponding per-row coefficient being equal to a third norm associated with the quantized gradient matrix.

Example 15 may include the subject matter of Example 4, wherein during backpropagation in the training process of the deep neural network, the gradient of a loss function with regard to the first step size is determined based on the maximum of the range and the number of elements of the activation matrix, and wherein the gradient of the loss function with regard to the second step size is determined based on the maximum of the range and the number of elements of the weight matrix.

Example 16 may include the subject matter of Example 1, wherein the deep neural network includes a transformer.

Example 17 may include the subject matter of Example 1, wherein the deep neural network is to be used for natural language processing, wherein the deep neural network takes, as its inputs, vector representations for words generated based on word-embedding.

Example 18 may include a computing device, comprising: memory for storing instructions; and one or more processing units coupled to the memory, wherein the instructions, when executed by the one or more processing units, cause the one or more processing units to perform any of the methods disclosed herein.

Example 19 may include a non-transitory computer-readable storage medium having stored thereon instructions that, when executed by one or more processing units, cause the one or more processing units to perform any of the methods disclosed herein.

Example 20 may include a computer program product comprising instructions that, when executed by one or more processing units, cause the one or more processing units to perform any of the methods disclosed herein.

What has been described above includes examples of the disclosed architecture. It is, of course, not possible to describe every possible combination of components and/or methodologies, but one of ordinary skill in the art may recognize that many further combinations and permutations are possible. Accordingly, the novel architecture is intended to embrace all such alterations, modifications and variations that fall within the spirit and scope of the present invention.

1-20. (canceled)

21. A computer-implemented method for accelerating operations of a deep neural network, comprising:
for each of a plurality of matrix multiplications during forward propagation, obtaining a first matrix by multiplying an activation matrix, which is an input of the matrix multiplication, with a block-diagonal Hadamard transform matrix;
obtaining a second matrix by multiplying a weight matrix, a transpose of which is another input of the matrix multiplication, with the block-diagonal Hadamard transform matrix;
quantizing the first matrix and the second matrix into 4-bit integer matrices;
obtaining a resultant matrix by multiplying the quantized first matrix and the transpose of the quantized second matrix; and
dequantizing the resultant matrix to a matrix of floating-point representation.

22. The computer-implemented method of claim 21, wherein the method is to be performed during a training process of the deep neural network.

23. The computer-implemented method of claim 21, wherein the block-diagonal Hadamard transform matrix is a block-diagonal matrix including multiple Hadamard transform matrices Hₖ, wherein k=5.

24. The computer-implemented method of claim 21, wherein the quantizing includes:
applying a clamp function to the first matrix and the second matrix,
respectively, to restrict each of elements in the first matrix and the second matrix into a range representable by 4-bit integers,
wherein a first step size for the activation matrix and a second step size for the weight matrix, each being a parameter of the clamp function, are floating-point scalars learnable during a training process of the deep neural network.

25. The computer-implemented method of claim 24, wherein the dequantizing includes:
multiplying the resultant matrix with the first step size and the second step size.

26. The computer-implemented method of claim 24, wherein whether or not to start optimizing each of the first step size and the second step size is to be determined when a rate of change of the corresponding step size over one or more iterations in the training process is less than a pre-determined threshold, or when a pre-determined number of epochs has been trained in the training process.

27. The computer-implemented method of claim 21, further comprising, during backpropagation in a training process of the deep neural network:
for computations associated with a gradient matrix representing gradient of a loss function with regard to an output of the matrix multiplication, splitting the gradient matrix into a first 4-bit integer gradient matrix and a second 4-bit integer gradient matrix, wherein the first 4-bit integer gradient matrix and the second 4-bit integer gradient matrix represent higher 4 bits and lower 4 bits of the gradient matrix, respectively.

28. The computer-implemented method of claim 27, wherein the splitting includes:
quantizing the gradient matrix into the first 4-bit integer gradient matrix associated with a first floating-point scalar; and
quantizing a difference between the gradient matrix and a product of the first 4-bit integer gradient matrix and the first floating-point scalar into the second 4-bit integer gradient matrix associated with a second floating-point scalar.

29. The computer-implemented method of claim 28, further comprising, for computation of weight gradient that involves a second matrix multiplication of a transpose of the gradient matrix with the quantized first matrix:
obtaining a third matrix by multiplying a transpose of the first 4-bit integer gradient matrix and the quantized first matrix;
obtaining a fourth matrix by multiplying a transpose of the second 4-bit integer gradient matrix and the quantized first matrix;
dequantizing the third matrix and the fourth matrix into matrices of floating-point representation; and
obtaining a resultant fifth matrix by summing the dequantized third matrix and the dequantized fourth matrix.

30. The computer-implemented method of claim 29, wherein in obtaining the third matrix and obtaining the fourth matrix, rows in the first 4-bit integer gradient matrix and the second 4-bit integer gradient matrix are sampled, with per-row random masks that follow Bernoulli distribution with corresponding per-row probabilities.

31. The computer-implemented method of claim 30, wherein each of the per-row probabilities is proportional to a corresponding per-row coefficient being equal to a product of a first norm associated with the quantized gradient matrix and a second norm associated with the quantized first matrix.

32. The computer-implemented method of claim 27, further comprising, for computation of activation gradient that involves a third matrix multiplication of the gradient matrix with the quantized second matrix,
obtaining a sixth matrix by multiplying the first 4-bit integer gradient matrix and the quantized second matrix;
obtaining a seventh matrix by multiplying the second 4-bit integer gradient matrix and the quantized second matrix;
dequantizing the sixth matrix and the seventh matrix into matrices of floating-point representation; and
obtaining a resultant eighth matrix by summing the dequantized six matrix and the dequantized seven matrix.

33. The computer-implemented method of claim 32, wherein in obtaining the sixth matrix and obtaining the seventh matrix, rows in the first 4-bit integer gradient matrix and the second 4-bit integer gradient matrix are sampled, with per-row random masks that follow Bernoulli distribution with corresponding per-row probabilities.

34. The computer-implemented method of claim 33, wherein each of the per-row probabilities is proportional to a corresponding per-row coefficient being equal to a third norm associated with the quantized gradient matrix.

35. The computer-implemented method of claim 24, wherein during backpropagation in the training process of the deep neural network, a gradient of a loss function with regard to the first step size is determined based on the maximum of the range and the number of elements of the activation matrix, and wherein the gradient of the loss function with regard to the second step size is determined based on the maximum of the range and the number of elements of the weight matrix.

36. The computer-implemented method of claim 21, wherein the deep neural network includes a transformer.

37. The computer-implemented method of claim 21, wherein the deep neural network is to be used for natural language processing, wherein the deep neural network takes, as inputs to the deep neural network, vector representations for words generated based on word-embedding.

38. A computing device, comprising:
memory for storing instructions; and
one or more processing units coupled to the memory, wherein the instructions, when executed by the one or more processing units, cause the one or more processing units to perform a method for accelerating operations of a deep neural network, the method comprising:
for each of a plurality of matrix multiplications during forward propagation,
obtaining a first matrix by multiplying an activation matrix, which is an input of the matrix multiplication, with a block-diagonal Hadamard transform matrix;
obtaining a second matrix by multiplying a weight matrix, a transpose of which is another input of the matrix multiplication, with the block-diagonal Hadamard transform matrix;
quantizing the first matrix and the second matrix into 4-bit integer matrices;
obtaining a resultant matrix by multiplying the quantized first matrix and the transpose of the quantized second matrix; and
dequantizing the resultant matrix to a matrix of floating-point representation.

39. A non-transitory computer-readable storage medium on which are stored instructions for accelerating operations of a deep neural network, the instructions, when executed by one or more processors, causing the one or more processors to perform the following steps:
for each of a plurality of matrix multiplications during forward propagation, obtaining a first matrix by multiplying an activation matrix, which is an input of the matrix multiplication, with a block-diagonal Hadamard transform matrix;
obtaining a second matrix by multiplying a weight matrix, a transpose of which is another input of the matrix multiplication, with the block-diagonal Hadamard transform matrix;
quantizing the first matrix and the second matrix into 4-bit integer matrices;
obtaining a resultant matrix by multiplying the quantized first matrix and the transpose of the quantized second matrix; and
dequantizing the resultant matrix to a matrix of floating-point representation.
